(19) United States
(12) Patent Application Publication
(10) Pub. No.: US 2016/0233675 A1
(43) Pub. Date: Aug. 11, 2016

(54) POWER CONVERSION DEVICE AND METHOD OF DRIVING THE SAME

(71) Applicant: SAMSUNG SDI CO., LTD., Yongin-si (KR)

(72) Inventors: Sangtaek Han, Yongin-si (KR); Prykhodko Stanislav, Yongin-si (KR)

(21) Appl. No.: 15/009,636

(22) Filed: Jan. 28, 2016

(30) Foreign Application Priority Data
Feb. 11, 2015 (KR) 10-2015-0021128

(51) Int. Cl. H02J 3/00; H02M 7/44; H02M 3/04

(52) U.S. Cl. CPC H02J 3/00; H02M 3/04; H02M 7/44

(57) ABSTRACT

A power conversion device includes: a first DC-DC converter configured to receive a first power from a first DC power source and to convert at least one of a voltage level and a current level to generate a first converted power; a DC-AC inverter electrically coupled to the first DC-DC converter and configured to convert the first converted power into a first AC power and to provide the first AC power to an external device; and a control unit configured to control the first DC-DC converter and the DC-AC inverter, wherein the first DC-DC converter and the DC-AC inverter are configured to be driven according to pulse width modulation (PWM) scheme using a first carrier frequency and a DC-AC carrier frequency, respectively, wherein a level of the first carrier frequency and a level of the DC-AC carrier frequency are determined according to predetermined time periods.

### CROSS-REFERENCE TO RELATED APPLICATION

This application claims priority to and the benefit of Korean Patent Application No. 10-2015-0021128, filed on Feb. 11, 2015, in the Korean Intellectual Property Office, the entire content of which is incorporated herein by reference in its entirety.

### BACKGROUND

1. Field

The present invention relates to a power conversion device and a method of driving the same.

2. Description of the Related Art

A power conversion device receiving direct current (DC) power and providing alternating current (AC) power has been studied, and research for increasing a level of provided AC power compared with a level of supplied DC power has been conducted. For example, in case of a power conversion device driven according to a pulse width modulation (PWM) scheme using a carrier frequency, an attempt to increase power conversion efficiency using a carrier frequency set in consideration of power consumption efficiency has been made.

However, when an optimal carrier frequency of a power conversion device is changed due to aging or replacement of a component of the power conversion device with the passage of time, it may not be possible to actively cope with the corresponding situation by changing the predetermined carrier frequency.

The above information disclosed in this Background section is only for enhancement of understanding of the background of the invention and therefore it may contain information that does not constitute prior art.

### SUMMARY

According to aspects of embodiments of the present invention, in a power conversion device and a method of driving the same, a power conversion device may be capable of determining a carrier frequency at every predetermined period (or according to predetermined periods) so that a frequency maximizing power conversion efficiency is determined newly to actively cope with a situation in which a component of the power conversion device is aged or replaced.

According to aspects of embodiments of the present invention, a power conversion device includes: a first DC-DC converter configured to receive a first power from a first DC power source and to convert at least one of a voltage level and a current level to generate a first converted power; a DC-AC inverter electrically coupled to the first DC-DC converter and configured to convert the first converted power into a first AC power and to provide the first AC power to an external device; and a control unit configured to control the first DC-DC converter and the DC-AC inverter, wherein the first DC-DC converter and the DC-AC inverter are configured to be driven according to pulse width modulation (PWM) scheme using a first carrier frequency and a DC-AC carrier frequency, respectively, wherein a level of the first carrier frequency and a level of the DC-AC carrier frequency are determined according to predetermined time periods.

The control unit may include: a measurement unit configured to measure measurement values comprising a level of the first power, a level of power provided from the DC-AC inverter, and a conversion efficiency of the first power; a calculation unit configured to calculate at least one of the level of the first carrier frequency and the level of the DC-AC carrier frequency corresponding to a maximum conversion efficiency among conversion efficiencies of the first power based on the conversion efficiencies of the first power received from the measurement unit, while changing the level of the first carrier frequency and the level of the DC-AC carrier frequency within an aggregation of levels of the carrier frequency; a storage unit configured to store the measurement values received from the measurement unit, and to store the first carrier frequency and the DC-AC carrier frequency corresponding to the measurement values received from the calculation unit; and a pulse generation unit configured to generate a pulse used for PWM based on a level of a frequency changed or determined by the calculation unit.

In a state of fixing the level of the DC-AC carrier frequency, the control unit may be configured to change the level of the first carrier frequency, to measure a conversion efficiency of the first power according to frequency levels, and to determine a frequency level corresponding to a maximum conversion efficiency among a plurality of measured conversion efficiencies of the first power, as a level of the first carrier frequency, and in a state of fixing the level of the first carrier frequency, the control unit may be configured to change the level of the DC-AC carrier frequency, to measure conversion efficiency of the first power according to frequency levels, and to determine a frequency level corresponding to the maximum conversion efficiency among the measured conversion efficiencies of the first power, as a level of the DC-AC carrier frequency.

The power conversion device may further include: a second DC-DC converter configured to receive second power from a second DC power source and to convert at least one of a voltage and a current level to generate a second converted power, and the second DC-DC converter may be configured to be driven according to a PWM scheme using a second carrier frequency, the DC-AC inverter may be electrically coupled to the second DC-DC converter, and may be configured to convert the second converted power into an AC power, and to provide the AC power, and the control unit may be configured to determine a level of the second carrier frequency according to the predetermined time periods, and while the control unit determines the level of the second carrier frequency, supply of the first converted power to the DC-AC inverter is cut off, and while the control unit determines the level of the first carrier frequency, supply of the second converted power to the DC-AC inverter is cut off.

The first DC-DC converter and the DC-AC inverter may be configured to be driven according to a PWM scheme further using a first dead time and a DC-AC dead time, respectively, and the control unit may be further configured to determine the first dead time and the DC-AC dead time according to the predetermined time periods.

According to some example embodiments of the present invention, in a method of driving a power conversion device including a plurality of DC-DC converters each receiving power by using a pulse width modulation (PWM) scheme using a carrier frequency, converting at least one of a voltage level and a current level, and generating converted power; and a DC-AC inverter converting the converted powers into AC power and providing the AC power to an external device, the method includes: coupling the power conversion device between a plurality of DC power sources and the external device; determining a DC-AC carrier frequency level; and completing determination of levels of the carrier frequencies of the plurality of DC-AC converters, wherein the determining of the DC-AC carrier frequency level is performed again when a predetermined period of time has lapsed after the completing the determination of the levels of the carrier frequencies of the plurality of DC-DC converters.

The method may further include: determining levels of carrier frequencies of some of the plurality of DC-DC converters, wherein the determining of the levels of the carrier frequencies of the some of the plurality of DC-DC converters may be performed before the determining the level of the carrier frequency of the DC-AC inverter after the coupling of the power conversion device between the plurality of DC power sources and the external device.

A level of a first carrier frequency used for PWM of a first DC-DC converter receiving first power, among the plurality of DC-DC converters, may be determined in the determining the levels of carrier frequencies of the some the plurality of DC-DC converters, and the determining of the levels of carrier frequencies of some of the plurality of DC-DC converters may include: supplying only first converted power from the first DC-DC converter to the DC-AC inverter; setting the level of the first carrier frequency of the first DC-DC converter to an initial level; when driving is performed with the first carrier frequency having the initial level, measuring a conversion efficiency of first power, defined as a ratio of power provided by the DC-AC inverter to the first power; and storing the conversion efficiency of first power and the initial level of the first carrier frequency, as a maximum conversion efficiency of the first power and an optimal carrier frequency level, respectively, wherein the storing of the conversion efficiency of first power and the initial level of the first carrier frequency, as the maximum conversion efficiency of the first power and the optimal carrier frequency level, respectively, is performed only when the optimal carrier frequency level has not been stored or the conversion efficiency of the first power is greater than the maximum conversion efficiency of the first power.

The determining of the levels of the carrier frequencies of the some of the plurality of DC-DC converters may further include: setting the level of the first carrier frequency to one of a plurality of levels for which conversion efficiency of the first power has not been measured, wherein, in the setting of the level of the first carrier frequency of the first DC-DC converter to the initial level, the initial level is a lowest level among levels that the first carrier frequency may have, and in the setting of the level of the first carrier frequency to one of levels for which conversion efficiency of the first power has not been measured, the level of the first carrier frequency is set to the lowest level among levels that the first carrier frequency may have but for which conversion efficiency of the first power has not been measured.

The determining of the level of the DC-AC carrier frequency may include: setting the level of the DC-AC carrier frequency to an initial level; when driving is performed with the DC-AC carrier frequency having the initial level, measuring a conversion efficiency of total power defined as a ratio of power provided by the DC-AC inverter to a sum of powers supplied to the power conversion device; and storing the conversion efficiency of total power and the initial level of the DC-AC carrier frequency as a maximum conversion efficiency of the total power and an optimal carrier frequency level, respectively, wherein the storing of the conversion efficiency of total power and the initial level of the DC-AC carrier frequency, as the maximum conversion efficiency of the total power and the optimal carrier frequency level, respectively, is performed only when the optimal carrier frequency level has not been stored or the conversion efficiency of the total power is greater than the maximum conversion efficiency of the total power.

The determining of the level of the DC-AC carrier frequency may further include: setting a level of a DC-AC dead time used by the DC-AC inverter to an initial level; and setting the level of the DC-AC dead time as one of levels for which conversion efficiency of total power has not been measured, wherein, in the determining of the level of the DC-AC carrier frequency, the level of the DC-AC dead time is further determined.

According to aspects of embodiments of the present invention, in a power conversion device and the method of driving the same, because a carrier frequency may be determined at every predetermined period, even though a component of the power conversion device is aged or replaced, a frequency maximizing power conversion efficiency may be determined again to thus actively cope with the corresponding situation.

### BRIEF DESCRIPTION OF THE DRAWINGS

Example embodiments of the present invention will now be described more fully hereinafter with reference to the accompanying drawings; however, they may be embodied in different forms and should not be construed as being limited to the embodiments set forth herein. Rather, these embodiments are provided so that this disclosure will be more thorough and complete, and will more fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a view illustrating a power conversion device according to some example embodiments of the present invention.

FIG. 2 is a view illustrating a power conversion device according to some example embodiments of the present invention.

FIG. 3 is a view illustrating a carrier pulse generated by the power conversion device according to some example embodiments of the present invention.

FIG. 4 is a view illustrating a method of driving a power conversion device according to some example embodiments of the present invention.

FIG. 5 is a view illustrating a process of determining a level of a carrier frequency of a portion of a plurality of DC-DC converters in a method of driving a power conversion device according to some example embodiments of the present invention.

FIG. 6 is a view illustrating a process of determining a level of a DC-AC carrier frequency in a method of driving a power conversion device according to some example embodiments of the present invention.

FIG. 7 is a view illustrating a process of determining a level of a carrier frequency of a plurality of DC-DC converters in a method of driving a power conversion device according to some example embodiments of the present invention.

FIG. 8 is a view illustrating a change in a level of a DC-AC carrier frequency in a process of determining a level of the DC-AC carrier frequency in the method of driving a power conversion device according to some example embodiments of the present invention.

### DETAILED DESCRIPTION

Hereinafter, example embodiments of the present invention will be described in more detail with reference to the accompanying drawings. Throughout the specification, the like reference numerals denote the substantially same elements. In describing the present invention, if a detailed explanation for a related known function or construction is considered to unnecessarily divert the gist of the present invention, such explanation may be omitted but would be understood by those skilled in the art. Names of elements used in the following description are selected for the purpose of description and may be different from those of actual products.

The present invention may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

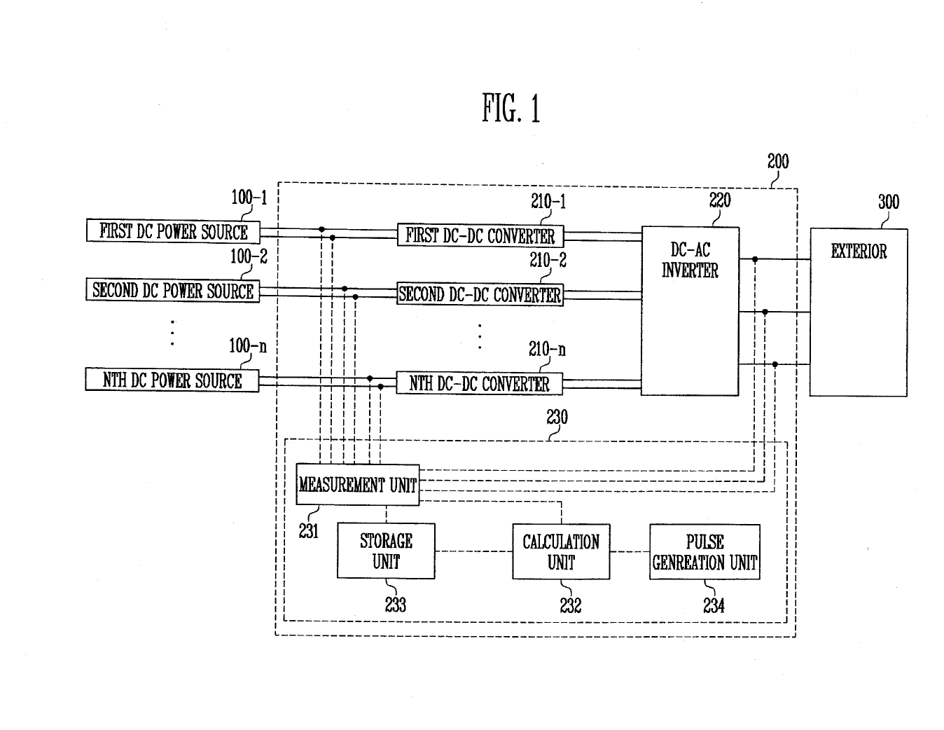

FIG. 1 is a view illustrating a power conversion device according to some example embodiments of the present invention. Referring to FIG. 1, a power conversion device 200 includes first to nth DC-DC converters 210-1 to 210-n (where n is a positive integer, and the first to nth DC-DC converters 210-1 to 210-n may, hereinafter, be collectively referred to with the reference numeral “210), a DC-AC inverter 220, and a control unit 230.

The first to nth DC-DC converters 210-1 to 210-n receive first to nth powers from the corresponding first to nth DC power sources 100-1 to 100-n (where the first to nth DC power sources 100-1 to 100-n may, hereinafter, be collectively referred to with the reference numeral “100”), respectively, and converts at least one of a voltage level and a current level, for example, of the received power to generate first to nth converted powers. For example, the first DC-DC converter 210-1 receives first power from the first DC power source 100-1 and converts at least one of a voltage level and a current level to generate converted first power. The first to nth DC-DC converters 210-1 to 210-n are driven according to a pulse width modulation (PWM) scheme using first to nth carrier frequencies, respectively. Also, the first to nth DC-DC converters 210-1 to 210-n may be resonant converters driven according to the PWM scheme further using first to nth dead times.

The DC-AC inverter 220 is electrically coupled to the first to nth DC-DC converters 210-1 to 210-n, and converts first to nth converted powers into AC powers and provides the same to the exterior (or external device) 300. The DC-AC inverter 220 may be driven according to a PWM scheme using a DC-AC carrier frequency, and may be a resonant converter driven according to a PWM scheme further using a DC-AC dead time. In FIG. 1, it is illustrated that the DC-AC inverter 220 provides power to the exterior 300 according to a 3-phase AC scheme, but this is merely illustrative.

The ratio of power provided by the DC-AC inverter 220 to the sum of the first to nth powers supplied to the power conversion device 200 may be defined as the conversion efficiency of total power. When the converted second to nth powers are not supplied to the DC-AC inverter 220, power provided by the DC-AC inverter 220 is based on first power. In this case, the ratio of power provided by the DC-AC inverter 220 to the first power may be defined as conversion efficiency of the first power. Conversion efficiency of the second to nth powers may also be defined similarly.

The control unit 230 may include a measurement unit 231, a calculation unit 232, a storage unit 233, and a pulse generation unit 234, and control the first to nth DC-DC converters 210-1 to 210-n and the DC-AC inverter 220. For the purposes of description, only the case of maximizing conversion efficiency of the first power will be described. The control unit 230 determines a level of the first carrier frequency and a level of the DC-AC carrier frequency at every predetermined period such that the conversion efficiency of the first power is increased (e.g., maximized). In a state in which the level of the DC-AC carrier frequency is fixed, the control unit 230 changes a level of the first carrier frequency, measures conversion efficiency of the first power according to frequency levels, and determines a frequency level corresponding to the maximum conversion efficiency among conversion efficiencies of the first power (referred to as “maximum conversion efficiency of first power”) as a level of the first carrier frequency.

Also, in a state in which the level of the first carrier frequency is fixed, the control unit 230 changes a level of the DC-AC carrier frequency, measures conversion efficiency of the first power according to frequency levels, and determines a frequency level corresponding to maximum conversion efficiency of the first power as a level of the DC-AC carrier frequency. For the second to nth powers, the control unit 230 may further control second to nth carrier frequencies and DC-AC carrier frequency such that conversion efficiency is maximized. The control unit 230 may determine a frequency level corresponding to the maximum conversion efficiency (hereinafter, referred to as “maximum conversion efficiency of total power”) among the measured conversion efficiency of total power, as the levels of the first to nth carrier frequencies or the level of the DC-AC carrier frequency. When the first to nth DC-DC converters 210-1 to 210-n and the DC-AC inverter 220 are resonant converters, the control unit 230 may further determine first to nth dead times and a DC-AC dead time.

The measurement unit 231 measures levels of the first to nth powers and a level of power provided from the DC-AC inverter 220. The measurement unit 231 may measure conversion efficiency of the total power on the basis of the sum of the first to nth powers and a level of power provided from the DC-AC inverter 220. When the second to nth converted powers are not supplied to the DC-AC inverter 220, the measurement unit 2321 may measure conversion efficiency of the first power on the basis of the level of power provided from the DC-AC inverter 220. The measurement unit 231 may measure conversion efficiency of the second to nth powers in a similar manner. That is, measurement values measured by the measurement unit 231 may include levels of the first to nth powers, a level of power provided from the DC-AC inverter 220, conversion efficiency of the first to nth powers, and total conversion efficiency.

The calculation unit 232 may change the level of the first carrier frequency and the level of the DC-AC carrier frequency within an aggregation of levels that the carrier frequency may have. For example, the aggregation of levels that the carrier frequency may have may be defined as a minimum level, a maximum level, and a difference in frequencies between neighboring levels among available levels. The calculation unit 232 may select one of levels available as the first carrier frequency and the DC-AC carrier frequency. Also, the calculation unit 232 may calculate at least one of the level of the first carrier frequency and the level of the DC-AC carrier frequency maximizing conversion efficiency of the first power on the basis of conversion efficiency of the first power received from the measurement unit. When the first DC-DC converter 210-1 and the DC-AC inverter 220 are resonant converters, the calculation unit 232 selects one of levels available as a first dead time and a DC-AC dead time, and calculates at least one of the level of the first dead time and the level of the DC-AC dead time maximizing conversion efficiency of the first power. An aggregation of levels that the dead time may have may also be defined as a minimum level, a maximum level, and a difference in dead times between neighboring levels among available levels.

The storage unit 233 stores measurement values from the measurement unit 231, and stores the first carrier frequency and the DC-AC carrier frequency corresponding to the measurement values received from the calculation unit 232. When the first DC-DC converter 210-1 and the DC-AC inverter 220 are resonant converters, the storage unit 233 may further store a first dead time and a DC-AC dead time. The stored data may not be erased even though a time period (e.g., a predetermined time period) has passed. However, when the time period (e.g., the predetermined time period) has lapsed and the level of the first carrier frequency and the level of the DC-AC carrier frequency are set again, the calculation unit 232 may calculate at least one of the level of the first carrier frequency and the level of the DC-AC carrier frequency maximizing conversion efficiency of the first power on the basis of only newly measured measurement values.

The pulse generation unit 234 generates a pulse used for PWM on the basis of a level of a frequency changed or determined by the calculation unit 232. The pulse is supplied to at least one of the first to nth DC-DC converters 210-1 to 210-n and the DC-AC inverter 220, but for the purposes of description, connection relationships between the pulse generation unit 234 and the first to nth DC-DC converters 210-1 to 210-n and the DC-AC inverter 220 is omitted. When the first DC-DC converter 210-1 and the DC-AC inverter 220 are resonant converters, the pulse generation unit 234 may generate a pulse having a set carrier frequency and a dead time, and supply the same to at least one of the first to nth DC-DC converters 210-1 to 210-n and the DC-AC inverter 220.

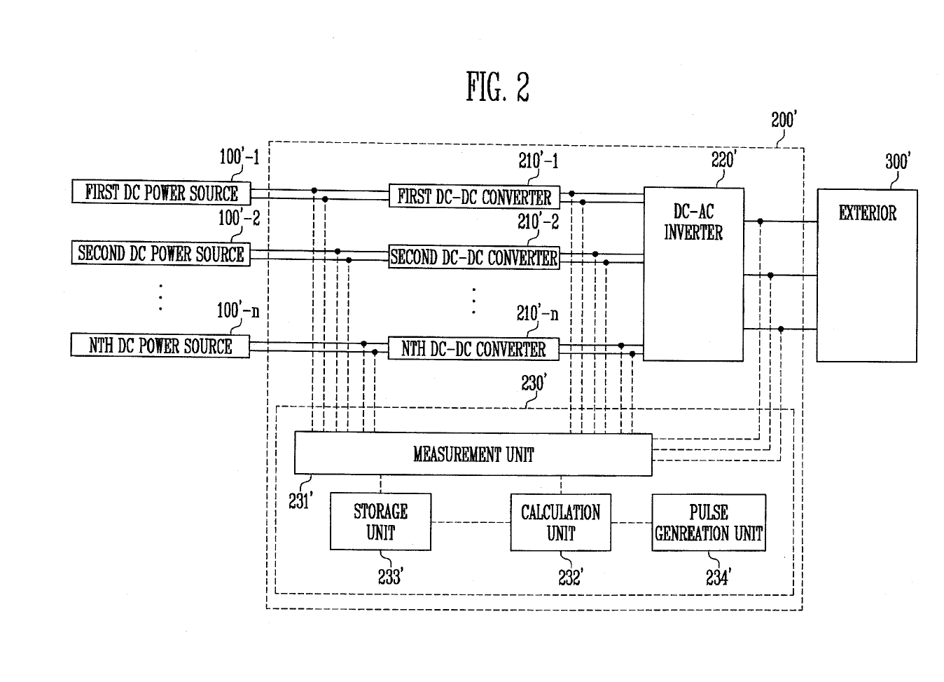

FIG. 2 is a view illustrating a power conversion device according to another embodiment of the present invention. Referring to FIG. 2, a power conversion device 200′ includes first to nth DC-DC converters 210′-1 to 210′-n (hereinafter, referred to as “210′”), a DC-AC inverter 220′, and a control unit 230′.

The first to nth DC-DC converters 210′ and the DC-AC inverter 220′ are the same as the first to nth DC-DC converters 210 and the DC-AC inverter 220, so a detailed description thereof may be omitted.

A measurement unit 231′ further measures levels of first to nth converted powers, in addition to measurement values measured by the measurement unit 231. In this case, the ratio of first converted power to first power (hereinafter, referred to as “conversion efficiency of first DC-DC converter”) may be independently accurately measured. Similarly, conversion efficiency of the second to nth DC-DC converters may also be independently accurately measured. Also, the ratio of power supplied by the DC-AC inverter 220′ to the sum of the first to nth converted powers (referred to as “conversion efficiency of DC-AC inverter”) may also be independently accurately measured.

A calculation unit 232′ may calculate a level of a first carrier frequency maximizing conversion efficiency of the first DC-DC converter 210J-1, while changing the first carrier frequency in a state in which the other carrier frequencies, excluding the first carrier frequency, are fixed. Similarly, the calculation unit 232′ may also calculate second to nth carrier frequencies and a DC-AC carrier frequency maximizing conversion efficiency of the second to nth DC-DC converters 210′-2 to 210′-n and the DC-AC inverter 220′. When the first to nth DC-DC converters 210′-1 to 210′-n and the DC-AC inverter 220′ are resonant converts, the calculation unit 232′ may calculate first to nth dead times and a DC-AC dead time.

A storage unit 233′ stores levels of first to nth converted powers, conversion efficiency of the first to nth DC-DC converters, and conversion efficiency of the DC-AC inverter, as well as the measurement values stored by the storage unit 233.

A pulse generation unit 234′ generates a pulse used for PWM on the basis of the level of the frequency changed or determined by the calculation unit 232′ in the same manner as that of the pulse generation unit 234. When the first DC-DC converter 201′-1 and the DC-AC inverter 220′ are resonant converters, the pulse generation unit 234′ may generate a pulse having a set carrier frequency and dead time and supply the same to at least one of the first to nth DC-DC converters 210′-1 to 210′-n and the DC-AC inverter 220′.

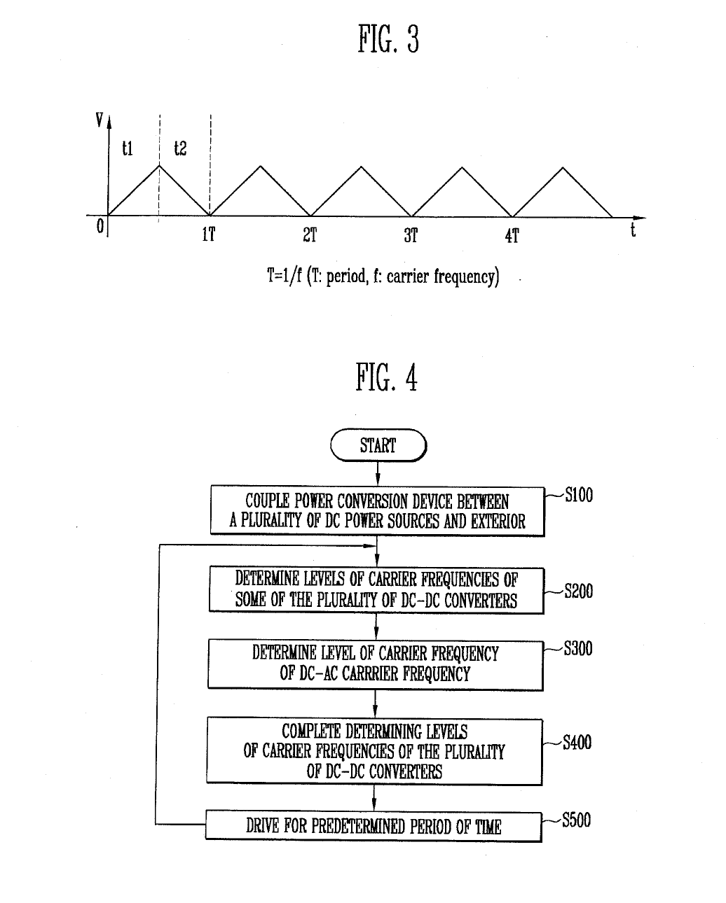

FIG. 3 is a view illustrating a carrier pulse generated by the power conversion device according to an embodiment of the present invention. Referring to FIG. 3, the same waveform of a carrier pulse is repeated at every period T. A change in a voltage V from a point in time (t) 0 to a first period T1 will be described. During a first period t1, a voltage level increases uniformly (e.g., at a constant rate or slope), and during a second period t2, the voltage level decreases uniformly (e.g., at a constant rate or slope). The period T is an inverse number of the frequency f (T=1/f). In FIG. 3, only a carrier slope in which the voltage level rises uniformly and subsequently falls uniformly is proposed, but this is merely illustrative. The voltage level may rise uniformly and fall instantaneously (or substantially instantaneously), or the voltage level may rise instantaneously (or substantially instantaneously) and subsequently fall uniformly.

FIG. 4 is a view illustrating a method of driving a power conversion device according to an embodiment of the present invention. Hereinafter, the method of driving a power conversion device will be described with reference to FIGS. 1, 3, and 4.

In operation S100, the power conversion device 200 is coupled between the plurality of DC power sources 100 and the exterior (or external device) 300. In detail, the plurality of DC power sources 100 are coupled to the plurality of DC-DC converters 210, respectively, and the exterior 300 is coupled to the DC-AC inverter 220.

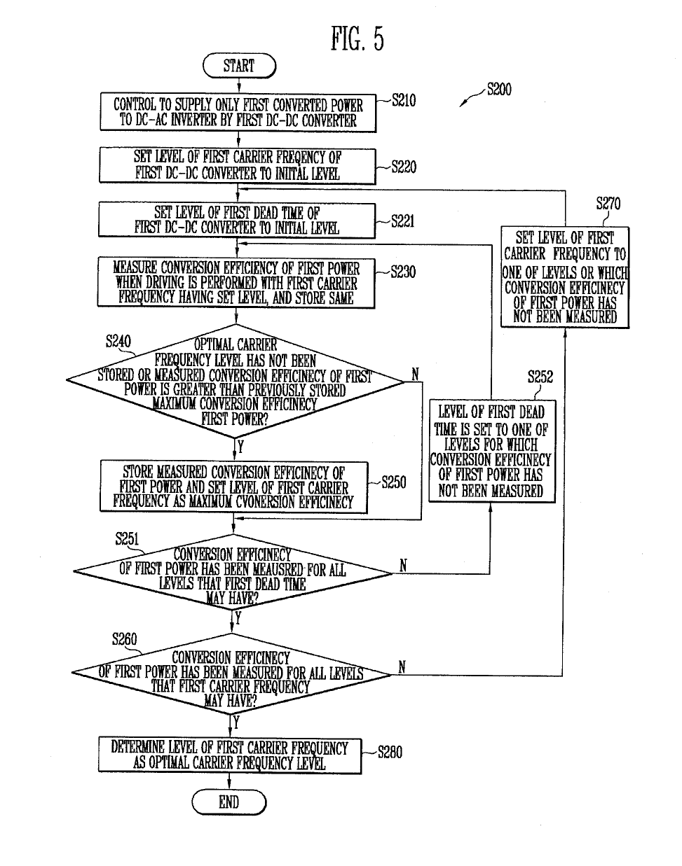

In operation S200, a level of carrier frequencies of some of the plurality of DC-DC converters 210. Hereinafter, it is assumed that only a level of a first carrier frequency used for PWM controlling of the first DC-DC converter 210-1 in operation S200. However, this is merely illustrative and a level of other carrier frequency may be determined. Operation S200 will be described in detail with reference to FIG. 5 hereinafter.

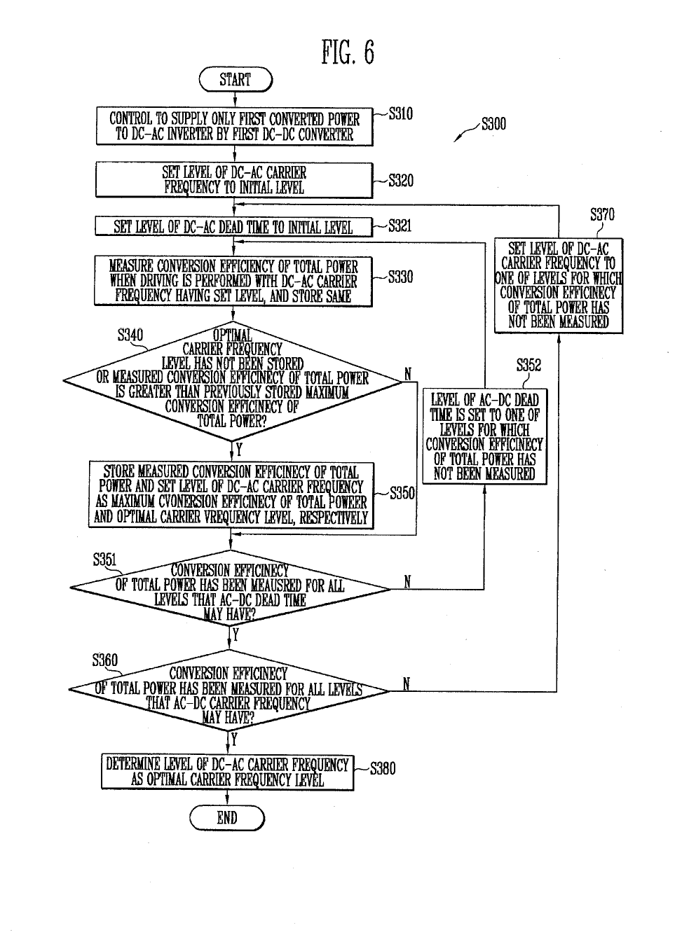

In operation S300, a level of a DC-AC carrier frequency is determined. Operation S300 will be described in detail with reference to FIG. 6 hereinafter.

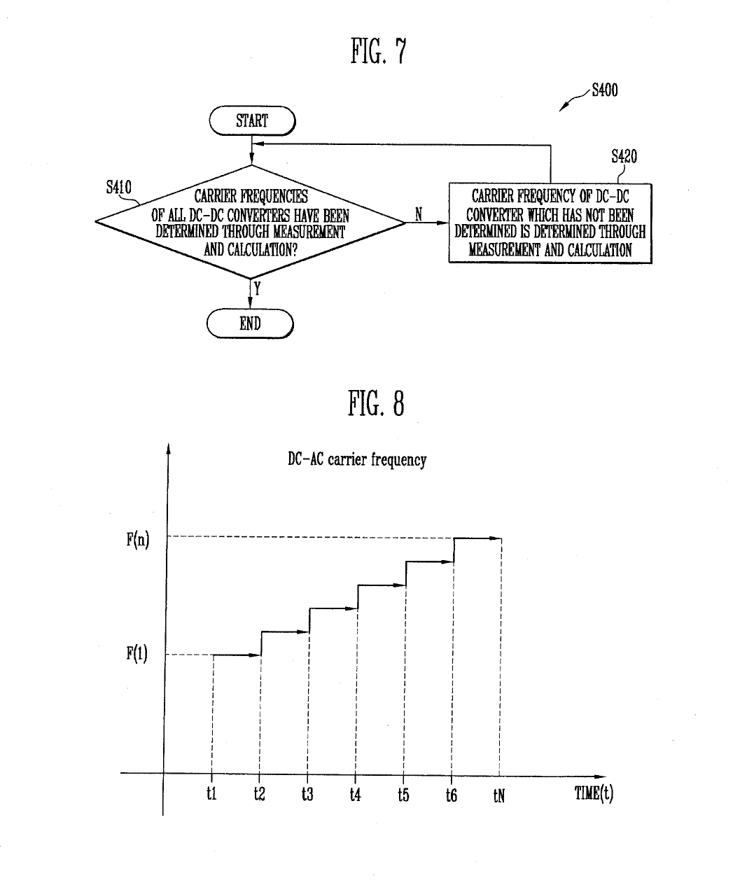

In operation S400, levels of carrier frequencies of DC-DC converters, excluding the DC-DC converter in which the level of the carrier frequency has been determined in operation S200, are determined. Hereinafter, it is assumed that levels of second to nth carrier frequencies used for PWM controlling of the second to nth DC-DC converters 210-2 to 210-n are determined. However, this is merely illustrative. Operation S400 will be described in detail with reference to FIG. 7 hereinafter.

In operation S500, because the carrier frequencies of all the converters 210 and 220, the power conversion device 200 is driven at the determined level of the carrier frequency for a period of time (e.g., a predetermined period of time). When the period of time (e.g., the predetermined period of time) has lapsed, operation S200 is performed again. When operation S200 is performed again, the carrier frequencies and the measurement values stored in the storage unit 233 are merely reference data and the first to nth carrier frequencies and the DC-AC carrier frequency have not be determined yet.

Operation S200 may be omitted. That is, a level of a carrier frequency may be first determined, and thereafter, levels of the first to nth carrier frequencies may be determined.

FIG. 5 is a view illustrating a process of determining a level of a carrier frequency of a portion of a plurality of DC-DC converters in a method of driving a power conversion device according to an embodiment of the present invention. Hereinafter, operation of determining levels of carrier frequencies of some of a plurality of DC-DC converters will be described with reference to FIGS. 1, 4, and 5.

In operation S210, because conversion efficiency of first power should be measured, the control unit 230 controls only to supply first converted power from the first DC-DC converter 210-1 to the DC-AC inverter 220. After operation S210, all the power provided by the DC-AC inverter 220 is based on the first power.

In operation S220, the control unit 230 sets a level of a first carrier frequency of the first DC-DC converter 210-1 to an initial level. Here, the initial level may be the lowest level among levels that the first carrier frequency may have.

In operation S221, the control unit 230 sets a level of a first dead time of the first DC-DC converter to an initial level. Here, the initial level may be the lowest level among levels that the first dead time may have.

In operation S230, conversion efficiency of the first power when driving is performed with the first carrier frequency having the set level is measured and stored. The measurement unit 231 measures measurement values including a level of the first power, a level of power supplied from the DC-AC inverter, and conversion efficiency of the first power. The storage unit 233 stores the measurement values received from the measurement unit 231, and stores the first carrier frequency and the DC-AC carrier frequency corresponding to the measurement values received from the calculation unit 232.

In operation S240, the measured conversion efficiency of the first power is compared with previously stored maximum conversion efficiency of the first power. If an optimal carrier frequency level has not been stored or if the measured conversion efficiency of the first power is greater than the previously stored maximum conversion efficiency of the first power, operation S250 is performed. If not, operation S260 is performed.

In operation S250, since the measured conversion efficiency of the first power is the maximum conversion efficiency of the first power, the measured conversion efficiency of the first power is stored as the maximum conversion efficiency. Also, the level of the first carrier frequency corresponding to the measured conversion efficiency of the first power is stored as an optimal carrier frequency level. When the first DC-DC converter is a resonant converter having a dead time, the level of the first dead time corresponding to the measured conversion efficiency of the first power is stored as an optimal the dead time level.

In operation S251, it is determined whether conversion efficiency of the first power has been measured for all the levels that the first dead time may have. When conversion efficiency of the first power has been measured for all the levels that the first dead time may have in a state in which the first carrier frequency is not changed, operation S260 is performed, and when a level has not been measured yet, operation S252 is performed.

In operation S252, the control unit 230 sets a level of the first dead time to one of levels for which conversion efficiency of the first power has not been measured. For example, the control unit may set the level of the first dead time to the lowest level among levels that the first dead time may have but for which conversion efficiency of the first power has not been measured yet. Thereafter, operation S230 is performed.

Operations S221, S251, and S252 are performed only when the first DC-DC converter is a resonant converter having a dead time. When a dead time is not used or not changed, operations S221, S251, and S252 may be omitted.

In operation S260, it is determined whether conversion efficiency of first power has been measured for all the levels that the first carrier frequency may have. When conversion efficiency of the first power has been measured for all the levels, operation S280 is performed, and if a level has not been measured, operation S270 is performed.

In operation S270, the control unit 230 sets a level of the first carrier frequency of the first DC-DC converter 210-1 to one of levels for which conversion efficiency of the first power has not been measured. Thereafter, operation S230 is performed.

In operation S280, since conversion efficiency of the first power has been measured for all the levels, the level of the first carrier frequency is determined as an optimal level of stored carrier frequency. When the first DC-DC converter is a resonant converter having a dead time, a level of the dead time is determined as an optimal level of the stored dead time.

In operation S200, whenever the conversion efficiency of the first power is measured, it is compared with the stored maximum conversion efficiency of the first power, but this is merely illustrative. For example, after conversion efficiency of the first power is measured for all the levels, the conversion efficiencies of the first power may be compared with each other.

FIG. 6 is a view illustrating a process of determining a level of a DC-AC carrier frequency in a method of driving a power conversion device according to an embodiment of the present invention. Hereinafter, an operation of determining a level of a DC-AC carrier frequency will be described with reference to FIGS. 1, 3, 4, and 5.

In operation S310, because conversion efficiency of first power should be measured, the control unit 230 controls to supply only the first converted power from the first DC-DC converter 210-1 to the DC-AC inverter 220. After operation S310, all the power provided by the DC-AC inverter 220 is based on the first power. Hereinafter, it is assumed that operation S310 is performed, and thus, conversion efficiency of total power is equal to conversion efficiency of the first power. However, this is merely illustrative. Operation S310 may be omitted when the level of the DC-AC carrier frequency is determined such that conversion efficiency of total power is maximized while a plurality of powers among first to nth powers is being supplied or when the first power is not supplied from the DC power source 100.

In operation S320, the control unit 230 sets the level of the DC-AC carrier frequency to an initial level. Here, the initial level may be the lowest level among levels that the DC-AC carrier frequency may have.

In operation S321, the control unit sets a level of the DC-AC dead time of the DC-AC inverter to an initial level. Here, the initial level may be the lowest level among levels that the DC-AC dead time may have.

In operation S330, conversion efficiency of total power when driving is performed with the DC-AC carrier frequency having a set level is measured and stored. The measurement unit 231 measures measurement values including a level of total power, a level of power supplied by the DC-AC inverter, and conversion efficiency of total power. The storage unit 233 stores the measurement values received from the measurement unit 231 and stores a first carrier frequency and the DC-AC carrier frequency corresponding to the measurement values received from the calculation unit 232.

In operation S340, measured conversion efficiency of total power is compared with previously stored maximum conversion efficiency of total power. When an optimal level of a carrier frequency has not been stored or the measured conversion efficiency of total power is greater than the previously stored maximum conversion efficiency of total power, operation S350 is performed. If not, operation S360 is performed.

In operation S350, because the measured conversion efficiency of total power is the maximum conversion efficiency of total power, the measured conversion efficiency of total power is stored as maximum conversion efficiency of total power. Also, a level of the DC-AC carrier frequency corresponding to the measured conversion efficiency of total power is stored as an optimal carrier frequency level. When the DC-AC inverter is a resonant converter having a dead time, a level of the DC-AC dead time corresponding to the measured conversion efficiency of total power is stored as an optimal level of dead time.

In operation S351, it is determined whether conversion efficiency of total power has been measured for all the levels that the DC-AC dead time may have. When conversion efficiency of total power has been measured for all the levels that the DC-AC dead time may have, operation S360 is performed, or if not, operation S352 is performed.

In operation S352, the control unit 230 sets a level of the DC-AC dead time to one of levels for which conversion efficiency of total power has not been measured. For example, the control unit 230 set the level of the DC-AC dead time to the lowest level among levels that the DC-AC dead time may have but for which conversion efficiency of total power has not been measured. Thereafter, operation S330 is performed.

Operations S321, S351, and S352 are performed only when the first DC-DC converter is a resonant converter having a dead time. When a dead time is not used or not changed, operations S321, S351, and S352 may be omitted.

In operation S360, it is determined whether conversion efficiency of total power has been measured for all the levels that the DC-AC carrier frequency may have. When conversion efficiency of total power has been measured for all the levels, operation S380 is performed, and if a level has not been measured, operation S370 is performed.

In operation S370, the control unit 230 sets a level of the DC-AC carrier frequency of the DC-AC inverter 220 to one of levels for which conversion efficiency of total power has not been measured. For example, the control unit 230 may set the level of the DC-AC carrier frequency of the DC-AC inverter 220 to the lowest level among levels that the DC-AC carrier frequency may have but for which conversion efficiency of total power has not been performed. Thereafter, operation S330 is performed.

In operation S380, because conversion efficiency of total power has been measured for all the levels, the level of the DC-AC carrier frequency is determined as an optimal level of stored carrier frequency. When the first DC-AC inverter is a resonant converter having a dead time, a level of the DC-AC dead time is determined as an optimal level of the stored dead time.

In operation S300, whenever the conversion efficiency of total power is measured, it is compared with the stored maximum conversion efficiency of total power, but this is merely illustrative. For example, after conversion efficiency of total power is measured for all the levels, the conversion efficiencies of total power may be compared with each other. Also, when the DC-AC inverter 220 is a resonant converter, a level of the DC-AC dead time may be further determined in operation S300. As described above with reference to FIGS. 5 and 6, according to the method of driving the power conversion device according to an embodiment of the present invention, levels of the carrier frequencies and dead time of the all the converters 210 and 220 included in the power conversion device are determined at every time period (e.g., predetermined time period) to maximize conversion efficiency.

FIG. 7 is a view illustrating a process of determining a level of a carrier frequency of a plurality of DC-DC converters in a method of driving a power conversion device according to an embodiment of the present invention. Hereinafter, an operation of completing determining levels of carrier frequencies of a plurality of DC-DC converters will be described with reference to FIGS. 1, 4, and 7.

In operation S410, it is checked whether carrier frequencies of all the DC-DC converters have been determined through measurement and calculation. When all the carrier frequencies have been determined, operation S400 is terminated, or if not, operation S420 is performed.

In operation S420, the control unit 230 determines a carrier frequency of a DC-DC converter whose carrier frequency has not been determined, through measurement and calculation. Details of operation S420 is very similar to those of operation S200, so a description thereof may be omitted.

FIG. 8 is a view illustrating a change in a level of a DC-AC carrier frequency in a process of determining a level of the DC-AC carrier frequency in the method of driving a power conversion device according to an embodiment of the present invention. Referring to FIG. 8, it can be confirmed that a carrier frequency F(1) set at a point in time t1 is the smallest among levels F(1) to F(n) that the carrier frequency may have. Thereafter, when a point in time t2 arrives, the carrier frequency rises to a value greater than F(1), and when a point in time tN arrives, the carrier frequency is changed to F(n) and a level of the DC-AC carrier frequency is determined as an optimal carrier frequency level. In FIG. 8, it is illustrated that the level of the carrier frequency increases with the passage of time, but a level of dead time may also increase with the passage of time.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims, and their equivalents.

What is claimed is:

1. A power conversion device comprising:
a first DC-DC converter configured to receive a first power from a first DC power source and to convert at least one of a voltage level and a current level to generate a first converted power;
a DC-AC inverter electrically coupled to the first DC-DC converter and configured to convert the first converted power into a first AC power and to provide the first AC power to an external device; and
a control unit configured to control the first DC-DC converter and the DC-AC inverter,
wherein the first DC-DC converter and the DC-AC inverter are configured to be driven according to pulse width modulation (PWM) scheme using a first carrier frequency and a DC-AC carrier frequency, respectively, wherein a level of the first carrier frequency and a level of the DC-AC carrier frequency are determined according to predetermined time periods.

2. The power conversion device of claim 1, wherein the control unit comprises:
a measurement unit configured to measure measurement values comprising a level of the first power, a level of power provided from the DC-AC inverter, and a conversion efficiency of the first power;
a calculation unit configured to calculate at least one of the level of the first carrier frequency and the level of the DC-AC carrier frequency corresponding to a maximum conversion efficiency among conversion efficiencies of the first power based on the conversion efficiencies of the first power received from the measurement unit, while changing the level of the first carrier frequency and the level of the DC-AC carrier frequency within an aggregation of levels of the carrier frequency;
a storage unit configured to store the measurement values received from the measurement unit, and to store the first carrier frequency and the DC-AC carrier frequency corresponding to the measurement values received from the calculation unit; and
a pulse generation unit configured to generate a pulse used for PWM based on a level of a frequency changed or determined by the calculation unit.

3. The power conversion device of claim 1, wherein, in a state of fixing the level of the DC-AC carrier frequency, the control unit is configured to change the level of the first carrier frequency, to measure a conversion efficiency of the first power according to frequency levels, and to determine a frequency level corresponding to a maximum conversion efficiency among a plurality of measured conversion efficiencies of the first power, as a level of the first carrier frequency, and
in a state of fixing the level of the first carrier frequency, the control unit is configured to change the level of the DC-AC carrier frequency, to measure conversion efficiency of the first power according to frequency levels, and to determine a frequency level corresponding to the maximum conversion efficiency among the measured conversion efficiencies of the first power, as a level of the DC-AC carrier frequency.

4. The power conversion device of claim 1, further comprising:
a second DC-DC converter configured to receive second power from a second DC power source and to convert at least one of a voltage and a current level to generate a second converted power,
wherein the second DC-DC converter is configured to be driven according to a PWM scheme using a second carrier frequency,
the DC-AC inverter is electrically coupled to the second DC-DC converter, and is configured to convert the second converted power into an AC power, and to provide the AC power, and
the control unit is configured to determine a level of the second carrier frequency according to the predetermined time periods, and
while the control unit determines the level of the second carrier frequency, supply of the first converted power to the DC-AC inverter is cut off, and while the control unit determines the level of the first carrier frequency, supply of the second converted power to the DC-AC inverter is cut off.

5. The power conversion device of claim 1, wherein the first DC-DC converter and the DC-AC inverter are configured to be driven according to a PWM scheme further using a first dead time and a DC-AC dead time, respectively, and the control unit is further configured to determine the first dead time and the DC-AC dead time according to the predetermined time periods.

6. A method of driving a power conversion device comprising a plurality of DC-DC converters each receiving power by using a pulse width modulation (PWM) scheme using a carrier frequency, converting at least one of a voltage level and a current level, and generating converted power; and a DC-AC inverter converting the converted powers into AC power and providing the AC power to an external device, the method comprising:
coupling the power conversion device between a plurality of DC power sources and the external device;
determining a DC-AC carrier frequency level; and
completing determination of levels of the carrier frequencies of the plurality of DC-DC converters,
wherein the determining of the DC-AC carrier frequency level is performed again when a predetermined period of time has lapsed after the completing the determination of the levels of the carrier frequencies of the plurality of DC-DC converters.

7. The method of claim 6, further comprising:
determining levels of carrier frequencies of some of the plurality of DC-DC converters,
wherein the determining of the levels of the carrier frequencies of the some of the plurality of DC-DC converters is performed before the determining the level of the carrier frequency of the DC-AC inverter after the coupling of the power conversion device between the plurality of DC power sources and the external device.

8. The method of claim 7, wherein a level of a first carrier frequency used for PWM of a first DC-DC converter receiving first power, among the plurality of DC-DC converters, is determined in the determining the levels of carrier frequencies of the some the plurality of DC-DC converters, and
the determining of the levels of carrier frequencies of some of the plurality of DC-DC converters comprises:
supplying only first converted power from the first DC-DC converter to the DC-AC inverter;
setting the level of the first carrier frequency of the first DC-DC converter to an initial level;
when driving is performed with the first carrier frequency having the initial level, measuring a conversion efficiency of first power, defined as a ratio of power provided by the DC-AC inverter to the first power; and
storing the conversion efficiency of first power and the initial level of the first carrier frequency, as a maximum conversion efficiency of the first power and an optimal carrier frequency level, respectively,
wherein the storing of the conversion efficiency of first power and the initial level of the first carrier frequency, as the maximum conversion efficiency of the first power and the optimal carrier frequency level, respectively, is performed only when the optimal carrier frequency level has not been stored or the conversion efficiency of the first power is greater than the maximum conversion efficiency of the first power.

9. The method of claim 8, wherein the determining of the levels of the carrier frequencies of the some of the plurality of DC-DC converters further comprises:
setting the level of the first carrier frequency to one of a plurality of levels for which conversion efficiency of the first power has not been measured,
wherein, in the setting of the level of the first carrier frequency of the first DC-DC converter to the initial level, the initial level is a lowest level among levels that the first carrier frequency may have, and
in the setting of the level of the first carrier frequency to one of levels for which conversion efficiency of the first power has not been measured, the level of the first carrier frequency is set to the lowest level among levels that the first carrier frequency may have but for which conversion efficiency of the first power has not been measured.

10. The method of claim 6, wherein the determining of the level of the DC-AC carrier frequency comprises:
setting the level of the DC-AC carrier frequency to an initial level;
when driving is performed with the DC-AC carrier frequency having the initial level, measuring a conversion efficiency of total power defined as a ratio of power provided by the DC-AC inverter to a sum of powers supplied to the power conversion device; and
storing the conversion efficiency of total power and the initial level of the DC-AC carrier frequency as a maximum conversion efficiency of the total power and an optimal carrier frequency level, respectively,
wherein the storing of the conversion efficiency of total power and the initial level of the DC-AC carrier frequency, as the maximum conversion efficiency of the total power and the optimal carrier frequency level, respectively, is performed only when the optimal carrier frequency level has not been stored or the conversion efficiency of the total power is greater than the maximum conversion efficiency of the total power.

11. The method of claim 10, wherein the determining of the level of the DC-AC carrier frequency further comprises:
setting a level of a DC-AC dead time used by the DC-AC inverter to an initial level; and
setting the level of the DC-AC dead time as one of levels for which conversion efficiency of total power has not been measured,
wherein, in the determining of the level of the DC-AC carrier frequency, the level of the DC-AC dead time is further determined.
